(19) United States
(12) Patent Application Publication
(10) Pub. No.: US 2017/0097992 A1
(43) Pub. Date: Apr. 6, 2017

(54) SYSTEMS AND METHODS FOR SEARCHING, COMPARING AND/OR MATCHING DIGITAL AUDIO FILES

(71) Applicant: Evergig Music S.A.S.U., Paris (FR)

(72) Inventors: Florent Vouin, Paris (FR); Nicolas Lapomarda, Paris (FR)

(73) Assignee: Evergig Music S.A.S.U., Paris (FR)

(21) Appl. No.: 14/873,658

(22) Filed: Oct. 2, 2015

(51) Int. Cl. G06F 17/30; G10L 25/51

(52) U.S. Cl. CPC G06F 17/30743; G10L 25/51; G06F 17/30752

(57) ABSTRACT

Systems and/or computer-implemented methods search, compare and/or match digital audio files, wherein the systems and/or methods provide a group of digital audio tracks to a computer system, wherein the group is provided to the computer system as input files or stored in a database associated with the computer system, wherein the group comprises a first digital audio track and a second digital audio track, wherein the first digital audio track is a live recording of a song and the second digital audio track is a previously recorded studio recording of a song. Moreover, the systems and methods compare audio features of the first and second digital audio tracks to determine whether the first and second digital audio tracks are a match comprising same performances of a same song or different performances of the same song, and output bounds for the match when the first and second digital audio tracks are determined to match, wherein the bounds for the match comprise start and end times for the match in both the first and second digital audio tracks.

### FIELD OF DISCLOSURE

The present systems and methods search, compare and/or match one or more portions of first digital audio files and one or more portions of second digital audio files of a same audio event and/or song. In embodiments, the present systems and methods search, compare and/or match one or more portions of one or more live digital audio recordings (hereinafter “live recordings”) and one or more portions of one or more previously recorded studio versions or recordings (hereinafter “studio recordings”) of the same audio event and/or song. In an embodiment, the present systems and methods match one or more live recordings to one or more studio recordings of the same audio event and/or song.

### BACKGROUND OF THE DISCLOSURE

There are known matching techniques that match one or more digital audio files which include a hashes technique, a chroma feature technique, a mel-frequency cepstral coefficients (hereinafter “MFCC”) technique, a notes intervals technique, a waveprint technique and a double Fourier transform technique. The hashes technique may provide easy lookup in a database, because the hashes technique only looks for exact matches; however, the matches must be an exact match, and are thus sensitive to slight changes in tempo and pitch of the songs (see Avery Li-chun Wang, “An Industrial-Strength Audio Search Algorithm,” 2003 (hereinafter “Wang”)). The chroma features technique may achieve a higher level representation, representing the twelve semitones of the scale, which provide an abstract representation closer to the “lead sheet” of the song; however, this technique loses a lot of information along with no more octaves and finer “pitch” (see Zhiyao Duan, et al. “A State Space Model for Online Polyphonic Audio-Score Alignment,” and “Aligning Semi-Improvised Music Audio with Its Lead Sheet,” 2011 and Joan Serra, et al., “Chroma Binary Similarity and Local Alignment Applied to Cover Song Identification,” 2007. The MFCC technique is far from the actual score and does not have a proper physical meaning, at least for audio music (see Mehryar Mohri, et al., “Efficient and Robust Music Identification with Weighted Finite-State Transducers,” 1-12, January 2008 (hereinafter “Mohri, et al.)). The notes intervals technique is used for a melody (monophonic) search and describes a melody, regardless of tempo and tonality; however, this technique is only useful for monophonic data which requires the true melody of every song to be initially found (see Dannenberg, et al.). The waveprint technique first computes the spectrogram, and then decomposes the spectrogram using thresholded wavelet coefficients which results in a more complex and accurate binary hash (see Shumeet Baluja, et al., “Waveprint: Efficient wavelet-based audio fingerprinting,” Pattern Recognition, 41(11):3467-3480, November 2008) (hereinafter “Baluja, et al.). The double Fourier transform technique finds variations in the spectrum, while removing the influence of the channel (see Mathieu Ramona, et al., “AudioPrint: An Efficient Audio Fingerprint System Based on a Novel Cost-less Synchronization Scheme,” 2013).

Known digital audio search techniques include a multiple exact fingerprint matches technique, an approximate matches using binary hashes technique a dynamic time warping technique hidden Markov models technique and a finite state transducer technique. The multiple exact fingerprint matches technique is used to find several independent matches, which are then linked together to provide exact matches in a database that is fast and easy; however, this technique generates false matches because of the relatively small number of fingerprints (see Wang). The approximate matches using binary hashes technique finds several independent matches, which are then linked together to provide approximate matches of binary hashes; however, this technique generates false matches (See Baluja, et al.). The dynamic time warping finds sequences of symbols and outputs “matching segments”/most probable paths, which gives more information than independent fingerprints; however, this technique is slow, and utilizes a plurality of parameters that specify the cost of a deletion, insertion, etc. (see Dannenberg, et al). The hidden Markov models technique finds sequences of symbols and find a high-level, abstract, description of the score which substantially (almost) “fully” describes a sequence of audio events; however, this technique runs an algorithm several times which may output different results (see Dannenberg, et al.). The finite state transducer technique finds sequences of symbols and describes the sequence and “factors” (subsequences) of the score (see Mohri, et al.). A transducer of the finite state transducer technique can be created to look for a sequence in a full database, just by following a single “path” in the state machine; however, the size of the transducer becomes huge when applied to a real database.

In view of the disadvantages of the above-identified known matching and searching techniques, improved matching and searching techniques are achievable by the present systems and methods.

### SUMMARY OF THE DISCLOSURE

In embodiments, the present systems and methods execute, implement and/or utilize one or more computer-implemented methods, one or more computer algorithms, one or more computer instructions and/or computer software (hereinafter “one or more computer instructions”) for matching at least one portion of live recordings to at least one portion of studio recordings of the same audio event or song (hereinafter “same event”). In embodiments, the same event may comprise one or more songs or portions of songs, albums or portion of albums, concerts or portions of concerts, speeches or portions of speeches, musicals or portions of musicals, operas or portion of operas, recitals or portions of recitals, performing arts of poetry and/or storytelling, works of music, artistic audio forms of expression and/or other known audio forms of entertainment. The one or more computer instructions, when executed, implemented and/or utilized by the present systems and methods, achieve performance-robust matching of same events along with a database lookup or search of the same events.

During the performance-robust matching method of the same events, the present systems and methods may execute and/or utilize the one or more computer instructions to compare one or more studio recordings to one or more live recordings of the same event while being robust enough to detect and/or analyze one or more variations in the performance of the same event. The timbre of the instruments played during the same event, the notes played or performed during the event, as well as the tempo of the event, may change throughout one or more portions of the same event. In embodiments, the present systems and methods may be configured and/or adapted to detect one or more rearrangements of the same event. Some artists performing events may, on occasion, transpose songs to be able to sing the songs properly, or not properly, which may constitute the one or more variations in the performances of the same event.

Hereinafter, the one or more live recordings may be referred to as the “query” and the one or more studio recordings of the artist may be referred to as the “database”. In embodiments, each query may be composed of one or more digital audio recordings which were previously recorded by one or more digital audio sensors during one or more previous performances of the same event. In some cases, the recorded one or more digital audio recordings or query may comprise noise and possibly distorted recordings previously recorded by the various audio sensors of one or more portable digital devices, such as, for example, one or more digital recording devices, one or more digital smart phones and/or one or more digital cameras.

During the performance-robust matching of songs facilitated by the present systems, methods and/or one or more computer instructions, transposed songs and heavily rearranged songs may or may not be considered as matches, which may also include major variations in the tempo of the song. In embodiments, most, if not every, audio features of the same event that is identifiable by human hearing senses may be considered a match. Usually, humans tend to recognize the melody of a song and/or the lyrics, independently of the tonality and the arrangement of the song. Although various researchers have examined the problem of melody extraction and lookup, the problem is not yet solved (see Roger B Dannenberg, et al., “A Comparative Evaluation of Search Techniques for Query-by-Humming Using the MUSART Testbed Query Processing and Music,” 58(3):1-19, 2007 (hereinafter “Dannenberg, et al.”) and Michael Skalak, et al., “Speeding Melody Search with Vantage Point Trees,” Ismir, 2008).

With respect to the database lookup of the same event, the one or more computer instructions may comprise at least one fine matching algorithm that, when executed or utilized by the present systems and methods, may output a match or a precise (“fine”) match which specifically details which parts of the songs match with respect to the live and studio recordings. The precise or fine match is outputted by the one or more computer instructions for use in potential applications, such as, for example, an equalization application, a restoration application of the live version, a production or creation of a single multi-angle digital video of the same event or song. The present systems and methods may equalize and/or restore the live version of the same song based on one or more precise or fine matches outputted by the present systems, methods and/or computer instructions. The present systems and methods may execute and/or perform fine matching of songs with a plurality of digital audio files. In embodiments, the present systems and method may already know or identify an artist who performed the same event. Therefore, the present systems and methods may test the query or live recordings against a discography of that artist comprising studio recordings by the artist. In embodiments, the present systems and methods may apply the fine matching algorithm to hundreds, or even thousands, of studio recordings, or even more, in a reasonable amount of time.

With respect to the database lookup, without artist a priori, the present systems and methods may not be able to identify the name of the artist. Thus, the present systems and methods may be required to test the query against several hundreds or thousands of songs, or even more. Every pair of digital audio files may not be fine tested, and the database lookup feature of the present systems and methods may have to first output a list of candidates or potential candidates for the unknown artist, which may then be tested using the one or more computer instructions executed by the present system and/or methods.

In embodiments, the systems and/or computer-implemented methods may search, compare and/or matching digital audio files and may provide a group of digital audio tracks to a computer system, wherein the group is provided to the computer system as input files or stored in a database associated with the computer system, wherein the group comprises a first digital audio track and a second digital audio track, wherein the first digital audio track is a live recording of a song and the second digital audio track is a previously recorded studio recording of a song. The systems and/or methods may compare audio features of the first and second digital audio tracks to determine whether the first and second digital audio tracks are a match comprising same performances of a same song or different performances of the same song and/or output bounds for the match when the first and second digital audio tracks are determined to match, wherein the bounds for the match comprise start and end times for the match in both the first and second digital audio tracks.

In embodiments, the first and second digital audio tracks may contain variations in tempo of the same song.

In embodiments, the systems and/or methods may shift one of the binary scores of the first and second digital audio tracks when a transposition of the same song is present within one of the first and second digital audio tracks.

In embodiments, the systems and/or methods may compute the binary score of each of the first and second digital audio tracks according to one of the following equations:

$$\begin{matrix}S [ i , n ] = ( {y}_{d B} [ i , n ] > {θ}_{active \text{-} note} ) , or & ( 7 ) \\ \overline{S} [ i , n ] = ( ( \frac{1}{J} {\sum }_{j} {S}_{j} [ i , n ] ) \geq {θ}_{group \text{-} active \text{-} note} ) . & ( 8 )\end{matrix}$$

In embodiments, the audio features may be based on binary scores of the first and second digital audio files.

In embodiments, the audio features may comprise hashes obtained from the binary score of each of the first and second digital audio files.

In embodiments, the systems and/or methods may store at least one selected from the outputted bounds and information associated with the match in a database of the computer system.

In embodiments, the systems and/or methods may produce a final output digital file based on one selected from the outputted bounds and the information associated with the match.

In embodiments, the present systems and/or computer-implemented methods may search, compare and/or match digital audio files and/or may provide digital audio tracks to a computer system, wherein the digital audio tracks are provided to the computer system as input files or are accessible from a database associated with the computer system, wherein the digital audio tracks comprise at least one live recording of a song and one or more previously recorded studio recordings of a song. The systems and/or methods may compute, independently, a binary score of each of the one or more previously recorded studio recordings and create a hash database of hashes obtained from the binary scores of the one or more previously recorded studio recordings. Further, the systems and/or methods may query the at least one live recording and the one or more previously recorded studio recordings to determine one or more matches based on the created hash database by computing a binary score of the at least one live recording, ranking the one or more previously recorded studio recordings according to probabilities of matching the at least one live recording based on the created hash database, and/or testing each of the one or more previously recorded studio recording until a match with the at least one live recording is determined or until a maximum number of tests with the previously recorded studio recordings is reached, wherein the one or more previously recorded studio recordings are tested in decreasing rank order or decreasing match likelihood and the match is a same performance of the same song or a different performance of the same song. Moreover, the systems and/or methods may output, when the match has been determined, bounds for the match, wherein the bounds for the match comprise start and end times for the match in both the live and previously recorded studio recordings.

In embodiments, the computed binary score of the one or more previously recorded studio recordings may be computed according to one of the following equations:

$$\begin{matrix}S [ i , n ] = ( {y}_{d B} [ i , n ] > {θ}_{active \text{-} note} ) , or & ( 7 ) \\ \overline{S} [ i , n ] = ( ( \frac{1}{J} {\sum }_{j} {S}_{j} [ i , n ] ) \geq {θ}_{group \text{-} active \text{-} note} ) . & ( 8 )\end{matrix}$$

In embodiments, the computed binary score of the at least one live recording may be computed according to one of the following equations:

$$\begin{matrix}S [ i , n ] = ( {y}_{d B} [ i , n ] > {θ}_{active \text{-} note} ) , or & ( 7 ) \\ \overline{S} [ i , n ] = ( ( \frac{1}{J} {\sum }_{j} {S}_{j} [ i , n ] ) \geq {θ}_{group \text{-} active \text{-} note} ) . & ( 8 )\end{matrix}$$

In embodiments, the match may be determined according to the following equation:

min(r_{1,2},r_{2,1})>−0.066max(L_{c})+3.1302 (19),

wherein L_{c} is in seconds and the r_{1,2}, r_{2, 1} are ratios between 0 and 1.

In embodiments, the systems and/or methods may store, when the match has been determined, at least one selected from the outputted bounds and information associated with the match in a database of the computer system.

In embodiments, the systems and/or methods may produce a final output digital file based on one selected from the outputted bounds and the information associated with the match.

### BRIEF DESCRIPTION OF THE DRAWINGS

The patent or application file contains at least one drawing executed in color. Copies of this patent or patent application publication with color drawing(s) will be provided by the Patent Office upon request and payment of the necessary fee.

So that the above recited features and advantages of the present systems and methods can be understood in detail, a more particular description of the present systems and methods, briefly summarized above, may be had by reference to the embodiments thereof that are illustrated in the appended drawings. It is to be noted, however, that the appended drawing illustrates only typical embodiments of the present systems and methods and are therefore not to be considered limiting of its scope, for the present systems and methods may admit to other equally effective embodiments.

FIG. 1 illustrates a block diagram of a computer system for matching live and studio recordings of a same song previously performed by a same artist in an embodiment.

FIG. 2 illustrates a graph, in color, showing responses of a filter bank H of a digital audio recording in an embodiment.

FIG. 3A illustrates a graph, in color, showing a spectrogram X of the digital audio recording shown in FIG. 2 in an embodiment.

FIG. 3B illustrates a graph, in color, showing filter bank outputs Y_{dB} of the digital audio recording shown in FIG. 2 in an embodiment.

FIG. 3C illustrates a graph, in color, showing LCNormalized outputs of the digital audio recording shown in FIG. 2 in an embodiment.

FIG. 3D illustrates a graph showing a binary score S of the digital audio recording shown in FIG. 2 in an embodiment.

FIG. 3E illustrates a graph showing a “denoised” score of the digital audio recording shown in FIG. 2 in an embodiment.

FIG. 4 illustrates a graph, in color, showing 2-dimensional filters applied to matrices and/or a smoothing kernel K applied to a dot product matrix D of digital audio recordings in an embodiment.

FIG. 5 illustrates a graph, in color, showing 2-dimensional filters applied to matrices and/or a diagonal kernel W′ used on D_{smoothed} of the digital audio recordings shown in FIG. 4 in an embodiment.

FIG. 6A illustrates a graph, in color, showing a score of a first digital audio recording in an embodiment.

FIG. 6B illustrates a graph, in color, showing a score of a second digital audio recording in an embodiment.

FIG. 6C illustrates a graph, in color, showing dot products of the first and second digital audio recordings shown in FIGS. 6A and 6B in an embodiment.

FIG. 6D illustrates a graph, in color, showing filter (smoothed) dot products of the dot products shown in FIG. 6C in an embodiment.

FIG. 6E illustrates a graph, in color, showing normalized dot products using LCN of the filter (smoothed) dot products shown in FIG. 6D in an embodiment.

FIG. 6F illustrates a graph, in color, showing detected connected components of the first and second digital audio recordings shown in FIGS. 6A and 6B in an embodiment.

FIG. 7A illustrates a graph of observation B of a digital audio recording in an embodiment.

FIG. 7B illustrates a graph, in color, of responsibilities y of the digital audio recording shown in FIG. 7A in an embodiment.

FIG. 7C illustrates a graph, in color, of log-likelihood and its relative improvement of the digital audio recording shown in FIG. 7A in an embodiment.

FIG. 7D illustrates a graph, in color, of chords-patterns φ of the digital audio recording shown in FIG. 7A in an embodiment.

FIG. 7E illustrates a graph of chord probabilities π_{c} of the digital audio recording shown in FIG. 7A in an embodiment.

FIG. 8A illustrates a graph of Hidden Markov Model training (hereinafter “HMMT”) applied to the observation B of the digital audio recording shown in FIG. 7A in an embodiment.

FIG. 8B illustrates a graph, in color, HMMT applied to the responsibilities y of the digital audio recording shown in FIG. 7B in an embodiment.

FIG. 8C illustrates a graph, in color, of HMMT applied to emission probabilities y of the digital audio recording shown in FIG. 7A in an embodiment.

FIG. 8D illustrates a graph, of HMMT applied to the chords probabilities shown in FIG. 7E in an embodiment.

FIG. 8E illustrates a graph, in color, of HMMT applied to log of the state transition matrix log(A) of the digital audio recording shown in FIG. 7A in an embodiment.

FIG. 8F illustrates a graph, in color, of HMMT applied to the log-likelihood and its relative improvements shown in FIG. 7C in an embodiment.

### DETAILED DESCRIPTION OF THE DISCLOSURE

The present systems and/or methods comprise one or more computer-implemented techniques and/or tools for detecting difference performances of the same songs. The present systems and/or methods compare, search and/or match different digital audio files containing the same or similar songs. The present systems and/or method utilize, implement and/or execute the one or more computer algorithms to compare, search and/or match one or more live recordings and one or more studio recordings of the same songs by one or more artists. The live recordings and/or studio recordings of the same song are digital audio tracks previously recorded by one or more digital recording devices. In embodiments, the live recordings may be previously recorded digital audio tracks or files previously recorded by at least one digital mobile device during one or more previous performances by the one or more artists, and the studio recordings may be digital audio tracks or files previously recorded at a music or performance studio or the like. The computer-implemented techniques and/or tools utilized by the present systems and/or methods may be in the form of at least one selected from computer-implemented steps or instructions, computer algorithms and/or computer software (hereinafter “at least one computer instructions”) that compares, searches and/or matches at least one live recording to at least one studio recording of the same song, when executed by one or more microprocessors associated with the present system and/or methods.

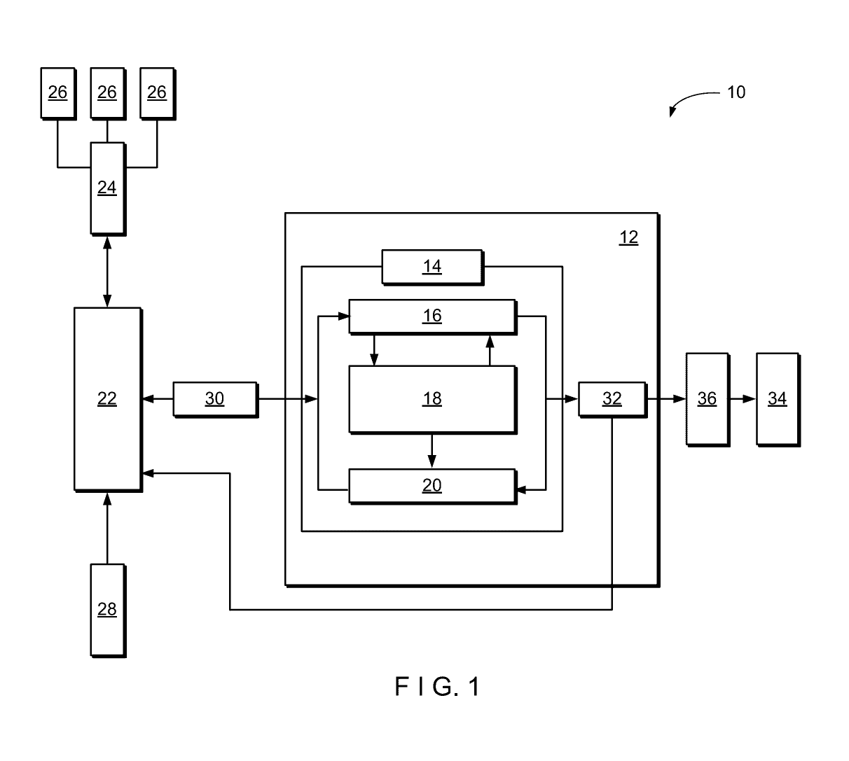

Referring now to the drawings wherein like numerals refer to like parts, FIG. 1 shows a computer system 10 (hereinafter “system 10”) configured and/or adapted for searching, comparing and/or matching one or more live recordings to at least one studio recording of the same song.

The system 10 comprises at least one computer 12 (hereinafter “computer 12”) which comprises at least one central processing unit 14 (hereinafter “CPU 14”) having at least one control unit 16 (hereinafter “CU 16”), at least one arithmetic logic unit 18 (hereinafter “ALU 18”) and at least one memory unit (hereinafter “MU 20”). One or more communication links and/or connections, illustrated by the arrowed lines within the CPU 14, allow or facilitate communication between the CU 16, ALU 18 and MU 20 of the CPU 14. The at least one computer instructions for searching, comparing and/or matching live recordings to studio recordings of the same song are uploaded and stored on a non-transitory storage medium (not shown in the drawings) associated with the MU 20 of the CPU 14. The one or more computer instructions may comprise, for example, a log-spaced filter bank algorithm (hereinafter “filter algorithm”), a normalizing the output of the filter bank algorithm (hereinafter “normalizing algorithm”), a binary score algorithm (hereinafter “binary algorithm”) and/or a features for a group of files algorithm (hereinafter “features algorithm”). Execution of one or more of the filter, normalizing, binary and/or features algorithms by the computer 12 may search, compare and/or match the live recording to the studio recording of the same song.

The system 10 may further comprise a database server 22 (hereinafter “server 22”) and a database 24 which may be local or remote with respect to the computer 12. The computer 12 may be connected to and/or in digital communication with the server 22 and/or the database 24, as illustrated by the arrowed lines extending between the computer 12 and the server 22 and between the server 22 and the database 24. In an embodiment not shown in the drawings, the server 22 may be excluded from the system 10 and the computer 12 may be directly connected to and in direct digital communication with the database 24. A plurality of digital media files 26 (hereinafter “files 26”) that are stored within the database 24 which are accessible by and transferable to the computer 12 via the server 22 or via a direct communication link (not shown in the drawings) between the computer 12 and the database 24 when the server 22 is excluded from the system 10. The files 26 stored within the database 24 comprise a plurality of studio recordings previously recorded by a plurality of artists and/or performers and/or a plurality of live recordings of at least one song previously recorded during a prior performance by at least one artist recorded by at least one digital input device 28 (hereinafter “device 28”).

The files 26 stored in the database 24 may comprise at least digital audio signals and optionally digital video signals. In embodiments, when the files 26 are digital multimedia files, the digital multimedia files contain a combination of different content forms, such as, for example, recorded digital audio and video signals. In embodiments, the studio recordings may be preloaded, transferred to and/or stored within the database 24 of the system 10, and the live recordings may have been uploaded, transferred to or transmitted to the system 10 via the device 28 which may be connectable to the system 10 by a communication link or interface as illustrated by the arrowed line in FIG. 1 between server 22 and device 28. In embodiments, the device 28 may be an augmented reality device, a computer, a digital audio recorder, a digital camera, a handheld computing device, a laptop computer, a mobile computer, a notebook computer, a smart device, a tablet computer or a wearable computer. The present disclosure should not be deemed as limited to a specific embodiment of files 26 and/or the device 28.

In embodiments, the CPU 14 may access the files 26, comprising one or more live recordings and/or studio recordings, which may be stored in and/or accessible from the database 24 such that the computer instructions may be executed, performed and/or implemented with respect to the files 26. In an embodiment, the CPU 14 may select the input audio tracks or files 30 (hereinafter “input 30”) from the files 26 stored in the database 24. The CPU 14 may transmit a request for accessing the input 30 to the server 22, and the server 22 may execute the request and transfer the input 30 to the CPU 14 of the computer 12. In embodiments, the input 30 comprises at least one live recording of the same song by the same artist and at least one studio recording of the same song by the same artist, wherein both the live and studio recordings are previously recorded and the at least one live recording was previously recorded by at least one device 28 during at least one prior performance previously performed by the same artist.

The CPU 14 of the computer 12 may execute or initiate the computer instructions stored on the non-transitory storage medium of MU 20 to perform, execute and/or complete one or more computer instructions, actions and/or steps associated the present inventive matching methods. Upon execution, activation and/or completion of the computer instructions, the CPU 14 may generate, produce, calculate or compute an output 32 which may be dependent of the specific inventive matching methods being performed by the CPU 14 or computer 12. In embodiments, the output 32 may be (i) a match comprising at least one live recording and at least one studio recording of the same song, (ii) spectrograms of the live and studio recordings, (iii) filter banks of the live and studio recordings, (iv) binary vectors of the live and studio recordings, (v) binary vectors or scores of the live and studio recordings, (vi) a final decision as to whether or not the live recording matches the studio recording, (vii) hashes representing pairs of notes for each binary vector or score of the live and studio recordings, a plurality of candidates from the studio recordings which may or may not match the live recording and/or (viii) one or more multi-angle videos of the same song comprising one or more of the live recordings of the files 26 from the input 28 that may match the studio recording of the same song.

For example, the systems 10 may, upon execution of the computer instructions, search, compare and/or match one or more live recordings to at least one studio recording of the same song which may be located within and/or present within the input 30. As a result, the output 32 may be, or may include, at least one match of at least one live recording to at least one studio recording of the same song by the same artist that may be contained within the input 30. In embodiment, the system 10 may, upon execution of the computer instruction, match at least one live recording or query file to at least studio recording or database file of the same song by the same artist from the input 30 to provide the matched live and studio recordings of the same song. As a result, the output 32 may comprise the matched live and studio recordings of the same song which may comprise digital audio and/or video features or recordings.

Additional the computer-implemented instructions, actions or steps that are performable or executable by the CPU 14 are subsequently discussed with respect to the inventive matching methods as disclosure herein. Upon execution of the computer instructions by the CPU 14, the system 10 may perform, complete or execute one or more of the inventive matching methods disclosed hereinafter by performing, completing or executing the additional computer-implemented instructions, actions or steps disclosed herein.

After the output 32 is created, produced and/or generated by the CPU 12, the output 32 may be transferred or transmitted to the server 22 which may store the output 32. Alternatively, the output 32 may be transferred to a memory 34 associated with the computer 12 via communication link 36 that may connect the CPU 14 and the memory 34 such that the CPU 14 may be in communication with the memory 34. The memory 34 may be local or remote with respect to the computer 12. In embodiments, the computer 12, the server 22, the database 24 and/or the memory 34 may be connected and/or in communication with one another via a digital communication network (not shown in the drawings) which may be a wireless network, a wired communication network or combination thereof. The digital communication network may be any digital communication network as known to one of ordinary skill in the art.

The present system 10 and/or methods may filter the input 30 via a log-spaced filter bank by executing, performing and/or implementing the filter algorithm. The filter algorithm may utilize higher level features that may be similar to a score of the song to detect different performances (i.e., live and studio recordings) of the same song as a match. The filter algorithm may compute audio features, such as, binary scores of live and studio recordings, of the input 30, or stored within the database 24. Utilizing the binary scores of the live and studio recordings improves the robustness of the matching to tempo and pitch variations achievable by the present system 10, methods and/or computer instructions.

In embodiments, the filter algorithm may start from a spectrogram of the same song, whereby each frame is described by a binary vector and each dimension is a musical note. As notes are log-spaced frequencies, the filter algorithm creates, produces and generates a filter bank that averages the frequency bins to create as many outputs or filters as needed according to equation (1):

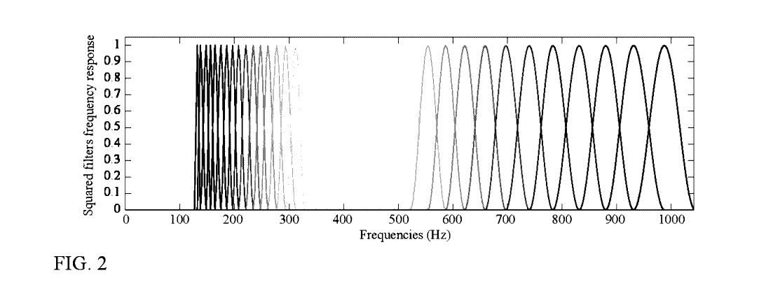

Y_{dB}=10 log₁₀(HX^{0.2}), (1)

where X is the M×N spectrogram (magnitude of the complex short-time Fourier transform (hereinafter “STFT”)), composed of M frequency bins and N time frames. To compute the spectrogram, the filter algorithm performs or executes fast Fourier transform algorithms (hereinafter “FFTs”) on frames M points, wherein M may be in a range from 256 to 65,536 points, weighted by a Blackman window. For example, M=16384 points, weighted by a Blackman window. The frames may have an overlap that is in a range from 25% to 75%. For example, the frames may have about a 50% overlap. H is the filter bank that computes the energy for each note of interest. In one embodiment, given a reference note (η_{ref}=69, f_{ref}=440 Hz), the center frequency of the filter i, corresponding to the note ηᵢ, is fᵢ=2^{ηi-ηref)}/¹²f_{ref}. The energies corresponding to 3 octaves (Nₙₒₜₑₛ=36) are computed, from η_{now}=48 (C3) to η_{high}=83 (B5). In other embodiments, f_{ref} may be in a range from 400 to 500 Hz, Nₙₒₜₑₛ may be in a range from 20 to 10, and/or n_{low} and/or n_{high} may be in a range from 30 to 100. The filter algorithm utilizes cosine filters and considers a sum to one in the frequency band. For readability, the filter algorithm, for example, defines f₋₁=2f₀−f₁ and f_{NNotes}=2f_{Nnotes-1}−f_{Nnotes-2}. The filter algorithm defines H_{i,m} according to equation (2) and the responses of the filter bank H are shown in FIG. 2:

$${H}_{i , m} = \{ \begin{matrix}0 & if f ( m ) \leq {f}_{i - 1} \\ {sin}^{2} ( \frac{π ( f ( m ) - {f}_{i - 1} )}{2 ( {f}_{i} - {f}_{i - 1} )} ) & if {f}_{i - 1} < f ( m ) \leq {f}_{i} \\ {cos}^{2} ( \frac{π ( f ( m ) - {f}_{i} )}{2 ( {f}_{i + 1} - {f}_{i} )} ) & if {f}_{i} < f ( m ) < {f}_{i + 1} \\ 0 & if f ( m ) \geq {f}_{i + 1}\end{matrix} \qquad ( 2 )$$

The present system 10 and/or methods may normalize the output of the filter bank H by executing, performing and/or implementing the normalizing algorithm. For example, Y_{dB} is the Nₙₒₜₑₛ×N matrix containing the energy (in decibels) for each note in time. To be robust to the possible variations in the equalization of the files 26 (i.e., live and studio recordings) and to detect local maxima, the normalization algorithm utilizes Local Contrast Normalization (hereinafter “LCN”). This LCN technique may be, for example, utilized in Computer Vision, but may also be an effective method to extract local peaks in the output of the filter bank Y_{dB}. The LCN technique may comprise normalizing each value in an image by removing the local mean computed within a window around the pixel, and then dividing it by the standard deviation in the same window. The mean and standard deviation calculations may be weighted using, for example, a L_{LCN}×N_{LCN} kernel W. In embodiments, the normalization algorithm may utilize the popular Gaussian distribution, centered on the pixel to normalize and in accordance with equations (3) and (4):

$$\begin{matrix}W [ i , n ] = \frac{1}{Z} {e}^{- \frac{{( i - {L}_{LCN / 2} )}^{2}}{2 {σ}_{i}^{2}} - \frac{{( n - {N}_{LCN / 2} )}^{2}}{2 {σ}_{n}^{2}}} & ( 3 ) \\ Z = {\sum }_{i , n} {e}^{- \frac{{( i - {L}_{LCN / 2} )}^{2}}{2 {σ}_{i}^{2}} - \frac{{( n - {N}_{LCN / 2} )}^{2}}{2 {σ}_{n}^{2}}} & ( 4 )\end{matrix}$$

where σᵢ=4L_{LCN} and σₙ=4N_{LCN}.

To increase calculation times, the normalization algorithm may utilize an approximation of such method. During a first pass, the normalization algorithm may remove a local mean from each pixel according to equation (5):

$${Y}_{d B} [ i , n ] ← {Y}_{d B} [ i , n ] - {\sum }_{{i}^{′} = 0}^{{L}_{LCN} - 1} {\sum }_{{n}^{′} = 0}^{{N}_{LCN} - 1} W [ {i}^{′} , {n}^{′} ] {Y}_{d B} [ i + {i}^{′} - \frac{{L}_{LCN}}{2} , n + {n}^{′} - \frac{{N}_{LCN}}{2} ] \qquad ( 5 )$$

During a second pass, the normalization algorithm may divide each pixel by the local standard deviation, which is computed from the output image of the first pass. It should be noted that this differs from the true definition, where the standard deviation should be computed by removing the same value to all samples in the window according to equation (6):

$${Y}_{dB} [ i , n ] ← \frac{{Y}_{dB} [ i , n ]}{\sqrt{\begin{matrix}{\sum }_{{i}^{′} = 0}^{{L}_{LCN} - 1} {\sum }_{{n}^{′} = 0}^{{N}_{LCN} - 1} 𝒲 [ {i}^{′} , {n}^{′} ] {Y}_{dB}^{2} \\ [ i + {i}^{′} - \frac{{L}_{LCN}}{2} , n + {n}^{′} - \frac{{N}_{LCN}}{2} ]\end{matrix}}} \qquad ( 6 )$$

In embodiments, utilizing normalization only along the frequency axis may achieve improved results, therefore N_{LCN}=1 and L_{LCN}=11. This may be due to the fact that rhythmic events (i.e., mostly the kick drum) cover the spectrum and; therefore; may create lots of peaks that may not be representative of the pitch content of the files 26 (i.e., live and studio recordings). By avoiding normalization along the time axis, the normalization algorithm may allow smaller peaks to be picked up in-between drum kicks.

By executing the binary algorithm from this normalized “image”, the binary algorithm may create, produce and/or generate a binary score S by thresholding the local peaks according to equation (7):

S[i,n]= [symbol] (y_{dB}[i,n]>θ_{active-note}) (7)

θ_{active-note} is a threshold that indirectly determines the sparseness of the score. In an embodiment, S may represent real musical events (i.e., notes).

Subsequently, the binary algorithm may remove isolated notes that may not be useful to the fingerprints and may merge long notes that were split because of a temporary decrease in energy. Temporary decreases may, for example, be caused by the kick drum, which may briefly make the other notes vanish. To denoise the score, the present systems 10 and/or method execute, perform and/or implement one or more methods similar to morphological operations on binary images. First, the binary algorithm may “erode” the binary score by removing peaks that have no neighbors in a 3×5 patch. This may be equivalent to setting to zero, all pixels where the response of the mask

$$[ \begin{matrix}1 & 1 & 1 & 1 & 1 \\ 1 & 1 & 0 & 1 & 1 \\ 1 & 1 & 1 & 1 & 1\end{matrix} ]$$

centered on the pixel is 0. The score may then be “dilated” by setting to one inactive notes surrounded by active notes. This may be equivalent to setting to one all pixels where the response of the mask [1 0 1], centered on the pixel, is about 2.

When several recordings (i.e., live and studio recordings) of the same performance or song are available, the present system 10 and/or method may merge the several recordings to try to obtain, or to obtain, a more accurate description of the audio frames within the several recordings. In embodiments, θ_{group-active-note} may be in a range from 0.1 to 0.8. In one embodiments, this merging of the several recordings may be achievable by summing the binary scores Sⱼ and thresholding the result according to equation (8):

$$\overline{S} [ i , n ] = ( ( \frac{1}{J} {\sum }_{j} {S}_{j} [ i , n ] ) \geq {θ}_{group \text{-} active \text{-} note} ) \qquad ( 8 )$$

where θ_{group-active-note}=0.3. As a result, a score may not be sparse enough which may deteriorate the matching results. This deteriorated matching results may be improvable if the (normalized) filter bank is summed before thresholding.

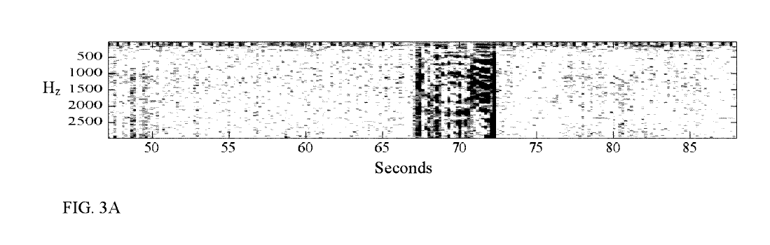

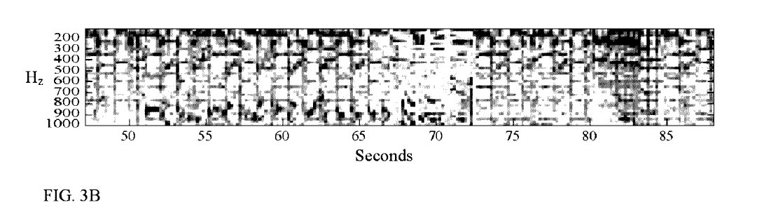

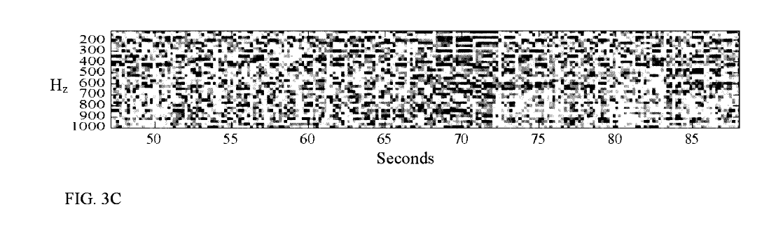

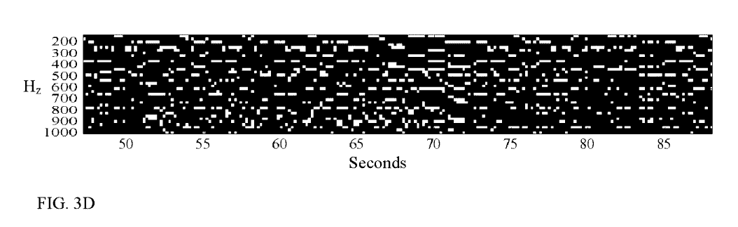

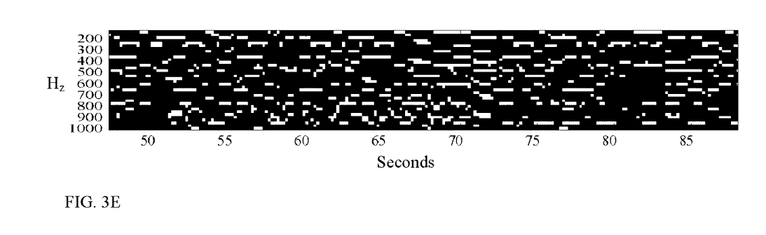

With respect to the filtering, normalizing, binary and features algorithms, FIG. 3A shows spectrogram X, FIG. 3B shows filter bank outputs Y_{dB}, FIG. 3C shows LCNormalized outputs, FIG. 3D shows binary score S, and FIG. 3E shows a denoised score.

For matchings scores of live and studio recordings, the present system 10 and/or method may, for example, utilize at least two binary scores obtained using or executing one or more of the filtering, normalizing, binary and features algorithms as previously discussed. The computer instructions may comprise one or more fine matching algorithms (hereinafter “matching algorithms”) which may be performed, executed and/or implemented by the present system 10 and/or methods to determine and/or detect a match or matches between the at least two binary scores.

In embodiments, matching algorithm, when two digital audio signals (i.e., live and/or studio recordings), determines whether the two digital audio signals are a match, whereby a match constitutes the same performance of the same song or different performances of the same song, or are not a match. When the two digital audio signals are determined to be a match by the matching algorithm, the matching algorithm outputs bounds for the match, whereby the bounds for the match comprise start and end times for the match in both the digital audio files. The matching algorithm is configured and/or adapted to handles, identify and compensate for slight variations in tempo contained within at least one of the two digital audio signals. When one or more transpositions are contained within at least one of the two digital audio signals, the matching algorithm may shift one of the binary scores of the two digital audio signals and/or may perform the same, substantially the same or a similar matching determination step to determine if the two digital audio signals are a match. The matching algorithm may test or compare each pair of digital audio tracks, contained within the input 30 or within the database 24, to find one or more matches between the digital audio tracks.

For example, the present system 10, method and/or matching algorithms may utilize at least a first binary score S₁ and a second binary score S₂ to determine and/or detect whether the first and second binary scores, S₁ and S₂, are a match and/or are or are not the same song. One method for determining whether S₁ and S² are matches is a dynamic time warping (hereinafter “DTW”) method (see Dannenberg, et al.). However, the present system 10, method and/or matching algorithms may utilize a method that is closely related to the DTW method but may rely more on image processing.

In embodiments, Dₘᵢₙ and/or Dₘₐₓ may be in a range from 0 to 1. For example, each feature or column of S₁ is compared against each feature of S₂, using a simple dot product according to equation (9):

$$D [ {n}_{1} , {n}_{2} ] = \frac{{\sum }_{i} {S}_{1} [ i , {n}_{1} ] {S}_{2} [ i , {n}_{2} ]}{\sqrt{{\sum }_{i} {S}_{1} [ i , {n}_{1} ] \times {\sum }_{i} {S}_{2} [ i , {n}_{2} ]}} \qquad ( 9 )$$

These similarity measures may then be thresholded:

D[n₁,n₂]←max(0,min(D[n₁,n₂],Dₘₐₓ)−Dₘᵢₙ) (10)

where Dₘᵢₙ=0.3 and Dₘₐₓ=0.7. Thresholding low values may refrain them from contributing to matches, and thresholding high values may avoid giving too much weight to localized perfect matches.

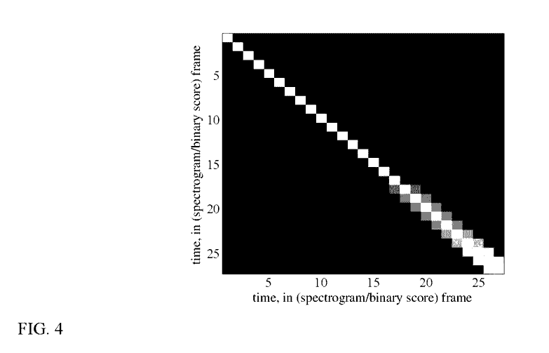

To take into account the possible changes in tempo between the two files 26 or scores (i.e., live and studio recordings), and the fact that some variations in the performance may lower the similarity (dot product) between the features of S₁ and S₂, D may be smoothed using a specific kernel. Smoothing may propagate matches to adjacent features, in order to find longer matching segments. For example, if the tempo is believed to be the same, smoothing may be performed using only a diagonal kernel. To be robust to tempo changes, the kernel may propagate matches not only to diagonal elements, but also to elements close to it as shown in FIG. 4. Further, FIG. 4 is a 2-dimensional filter applied to matrices, whereby the filter is applied to the “dot product matrices” D, where the two dimensions represent time. Thus, the units of measure for both x- and y-axes of FIG. 4 are times, in (spectrogram/binary score) frames. In some way, this may be similar to a DTW algorithm, where “deletion” and “insertion” may be possible between adjacent features.

$$K [ {n}_{1} , {n}_{2} ] = 1 - max ( 0 , min ( 1 , \vert \frac{{n}_{2}}{{n}_{1}} - 1 \vert \text{/} KernelDrift ) ) \qquad ( 11 )$$

KernelDrift may define the allowed tempo difference between two matching files 26 (i.e., live and studio recordings).

Once the present system 10, method and/or matching algorithms obtain the smoothed version of the dot products, D_{smoothed}, LCN may be utilized and/or performed or executed to outline the matching segments of S₁ and S₂. In embodiments, the present system 10, method and/or matching algorithms may not utilize a Gaussian kernel, because highlighting diagonal matching segments in D_{smoothed} is desirable. As a result, the present system 10, method and/or matching algorithms may utilize a kernel composed of the opposite diagonal according to equation (12):

$${𝒲}^{′} [ {n}_{1} , {n}_{2} ] = \{ \begin{matrix}\frac{1}{Z} {e}^{- \frac{{( {n}_{1} - L / 2 )}^{2}}{{σ}^{2}}} & if {n}_{2} = L - {n}_{1} - 1 \\ 0 & otherwise\end{matrix} \qquad ( 12 )$$

where Z is the normalizing factor to make elements of W′ sum to one.

Once normalized, the image D_{N} may be thresholded to keep only matching or substantially matching segments. The binary image representing these segments is defined according to equation (13):

M[n₁,n₂]= [symbol] (D_{N}[n₁,n₂]>θ_{match}) (13)

with θ_{match}=1.2. From the binary matrix M, the present system 10 and/or methods may extract the connected components, which all represent a matching segment. Each component c may be defined by the pixels (i.e., matching dot products) in it: C_{c}={(n1, n2)}. To be kept as a true match, the components must have a minimum length Lⁿ¹_{c}≧Lₘᵢₙ where:

L′_{c}=max(C_{c})−min(C_{c}) (14)

When converted back to seconds, the present system 10, method and/or matching algorithms may set Lₘᵢₙ=15 seconds (hereinafter “s”). Also, the segments must have a minimum match value:

max(D_{smoothed}[C_{c}])≧Dₘᵢₙ (15)

For components that verify these two conditions, the present system 10 and/or method may compute the parameters p=[a b]^{T} of the line n₂=[n₁ 1]p, by applying a weighted least square regression according to equations (16)-(18):

p=(X^{T}WX)⁻¹X^{T}W[C(n₂)] (16)

X=[C(n₁)l_{|C(n1|,1}] (17)

W=diag(D_{smoothed}[C_{c}]) (18)

In embodiments, MaxDrift may be in a range from 0 to 0.4. In one embodiments, a final condition for a segment to be accepted as a true match is that the segment should, or must, be diagonal, i.e. |a−1<MaxDrift, with MaxDrift=0.2.

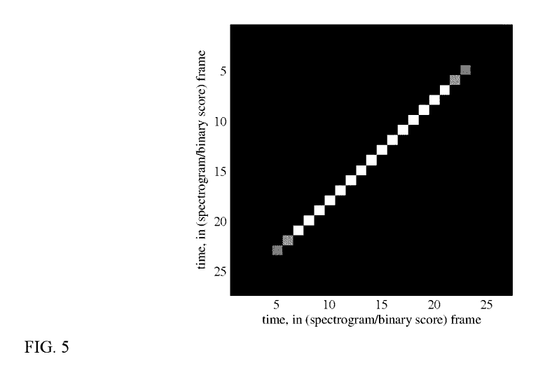

In an embodiment, FIG. 5 shows diagonal kernel W′ used on D_{smoothed}. Further, FIG. 5 is a 2-dimensional filter applied to matrices, whereby the filter is applied to the “dot product matrices” D, where the two dimensions represent time. Thus, the units of measure for both x- and y-axes of FIG. 5 are times, in (spectrogram/binary score) frames.

The matching segments may be defined by their boundaries [minₙ₁(C_{c})maxₙ₁(C_{c})] and the line parameters p_{c}. To output a final decision regarding the two files (i.e., S₁ and S₂), the present system 10, methods and/or matching algorithms may utilize the maximum length amongst matching segments, and the percentage of the file covered by all segments r_{1,2} and r_{2,1}. Two files may satisfy:

min(r_{1,2},r_{2,1})>−0.066max(L_{c})+3.1302 (19)

Numerical values were found experimentally (L_{c} is in seconds and the r are ratios between 0 and 1). As a result, no false positives were obtained.

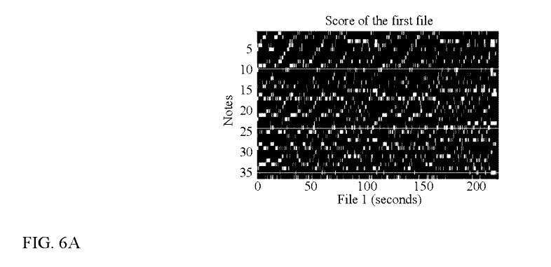

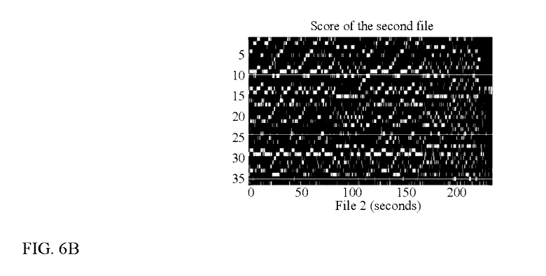

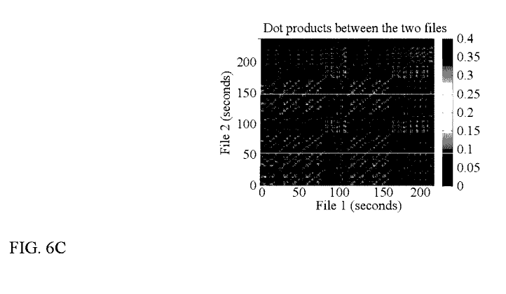

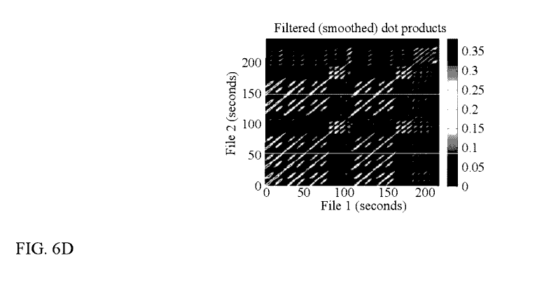

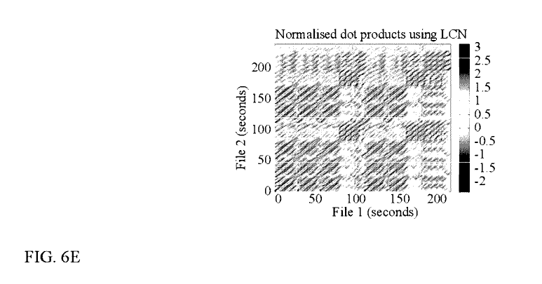

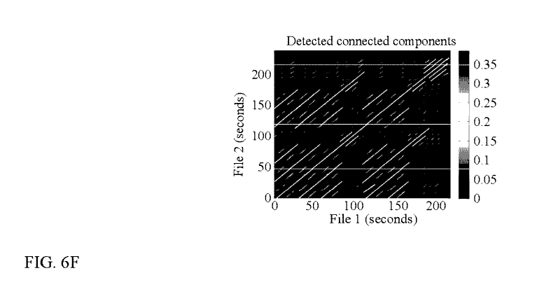

FIGS. 6A-6F. shows intermediate results of the present matching algorithm. The dot product between the two scores, S₁ and S₂, is computed which is then smoothed, and normalized. Subsequently, relevant connected components are retrieved and line parameters are computed.

As a result, songs may be manually labeled from at least one list of a plurality of concerts. In an example, more than one hundred matches were labelled, linking “chunks” of songs from a website or uploadable from the device 28 with studio recordings of the songs stored in the database 24. Because a chunk of a live recording may contain several songs, a single chunk may match several different studio recordings. It must be noted that some of the live recordings were transposed, i.e. sung or performed in a different tonality. Transposed recordings are matchable via the present matching algorithm by shifting the input binary score in frequency and/or notes. Out of the matches, more than one hundred matches were “easy”, meaning that the live and studio recordings are in the same, or substantially the same, tonality, with approximately the same, or substantially the same, tempo. The parameters of the present matching algorithm were tuned to obtain zero false positives, which slightly decreased the number of true positives as well. The present system 10, methods and/or matching algorithm successfully found more than one hundred true matches, which corresponds to about 81% of the total number of matches, or about 91% of the easy matches.

In embodiments, noise may be handled, managed and/or processed by aggregating the features of several files or recordings at the same time using synchronization information obtained from the computer instructions or other computer algorithms. As a result, the aggregation procedure may be improved, and may sometimes create too many notes. Often, the live recordings may contain more peaks and/or is less sparse which may be noise, actual peaks caused by interferences (i.e., people talking), or because of the aggregation procedure itself.

In embodiments, the dot product technique is used to find matches between features or columns of binary scores of live and studio recordings. If these features are not noisy, the dot product technique may be acceptable. On the other hand, noise may be dealt with, processed and/or managed by smoothing and defining various thresholds to find matches.

As previously set forth, the live recording often contains more peaks than the studio recording which may be dealt with by considering that dot products over a specified threshold are matches, even though the recordings are not exactly the same or substantially the same.

On occasion, it may happen, or occur, that two features match in different songs which may not be seen as an error, as this may be perfectly plausible. If this is the case, the present system 10, methods and/or computer instructions may check consistency in time, making sure that several matches occur in a row, at a constant, but possibly different, tempo compared to the studio recording. Improvements may be achieved by, for example, taking notes/chords duration into account, to avoid false positives caused by a single chord matching between two files, and determining or detecting a different way of finding matches that span in time which may or may not be performed and/or executed by filtering/least squares matching.

In an example, DTW programming was tested and allowed the present system 10, methods and/or computer instructions to give less importance to contiguous matches corresponding to the same chord spanning over a long period of time. Increased importance may be given to matching features that correspond to several chords in a row which may lead to detection of a real sequence of notes.

In embodiments, the present system 10 and/or methods may be configured and/or adapted to find, determine and/or detect matches, or at least candidates for matches, in a large scale database via a database lookup or search algorithm or method (hereinafter “lookup algorithm”). The present system 10 and/or methods perform, execute and/or accomplish the database lookup algorithm based on the same or substantially the same features utilized during the fine matching binary scores and/or live and studio recordings. The lookup algorithm may be utilized as a step executed prior to the execution of the matching algorithm or step. The lookup algorithm may find potential matches (i.e., one or more studio recordings) for a query file (i.e., a live recording) in a real-sized database (i.e., database 24), and may test or compare a few, or one or more, of the potential matches using the matching algorithm. The lookup algorithm may utilize the same audio features as the matching algorithm, such as, for example, binary scores of the live and studio recordings. The lookup algorithm may rank all, or some, of the database files (i.e., live and/or studio recordings), contained in the input 30 and/or stored within the database 24, in order of decreasing matching probability with the query file (i.e., the live recording). The lookup algorithm may rank all, or some, of the files based on a hash database, where hashes are extracted from binary scores of all, or some, of the database files. Once all, or some, of the database files are sorted in decreasing likelihood order, the matching algorithm may test or compare the first, or highest ranking, database files against the query file to determine whether one or more matches exist and/or are present. The matching algorithm may proceed and/or continue the matching algorithm find, determines and/or identifies one or more matches that cover or extend over a predetermined or preset length of the query file and/or when the matching algorithm may have reached a maximum number of database files to test or compare from the input 30 and/or the database 24.

In an embodiment, the lookup method may be based or substantially based on “pairs of landmarks” descriptors (see Wang). For each binary score, hashes representing pairs of notes are created by the present system 10 and/or the lookup method. During the lookup method, perfect matches are retrieved from the database 24. Criteria may then be computed to estimate the similarity between the query and each song in the database 24. The songs in the database 24 are then ordered by descending values of similarity. The performance of the system 10 and/or database lookup method may be determined by the position (rank) of the ground truth matches in this ordering. In an embodiment, the goal of the system 10 and/or the lookup method may be to obtain a reduced number of candidates for matches using only or substantially only computations. The candidates may then be analyzed more precisely using the matching algorithm. A rank of the ground truth match may directly determine the resources utilized and/or the time needed for the search, assuming the matching algorithm may identify the ground truth match.

To obtain a best, or substantially best representation, for the binary score, the present system 10 and/or the lookup method may select pairs of notes that may be the most likely, or substantially the most likely, to appear in both the live and studio recordings. In order to select the pairs of notes, the present system 10 and/or the lookup method may avoid creating pairs of notes based on what may be, or is, noise. Also, the pairs of notes should be evenly spread across the entire, or substantially entire, score. In an embodiment, these constraints may be satisfied by defining a constant density of intervals in the file or recording, and/or by keeping only intervals between the longest notes.

In embodiments, each note a may be defined by its pitch iₐ, its position in the score nₐ, and its length lₐ. The interval between two notes is defined by three values (iₐ, Δn, Δi) where iₐ is the pitch of the first note, Δn is the time difference between the first and second note (n_{b}−nₐ>0), and Δi is the interval (as defined in music) between the two pitches (i_{b}−iₐ). This triplet or three values is linked to its absolute position in the song nₐ. A “strength” to the interval may also be assigned, defined as s=min (lₐ, l_{b}). As a result, five values may be obtained in accordance with equation (20):

(nₐ,(iₐ,Δn,Δi),s) (20)

In embodiments, intervals satisfying specific constraints may be listed as follows. First, the time difference between the two notes must be strictly positive, and is bounded in time: Δn∈[Δnₘᵢₙ, Δnₘₐₓ], which may ensure that the intervals actually describe a temporality of the song or binary score, and not just the harmony of the song or score. Second, the interval must not be zero, and is bounded to 6 semitones: Δi∈[−6,6]\0. Although a repeated note also contains information, the present system 10 and/or lookup method may not want to rely on notes that could have been split during the creation of the binary score. In other embodiments, Δi may be in a range from −30 to 30.

In embodiments, dᵢₙₜₑᵣᵥₐₗₛ may be in a range from 1 to 30 Hz, Lwindow may be in a range from 1 to 20 seconds, and bounds for the in Δn may be in a range from 1 to 60. For choosing the best intervals, listing all intervals may create far too many hashes. Therefore, the present system 10 and/or lookup method may limit the number of “fingerprints” by fixing a density of intervals throughout the song or binary score. For example, the present system 10 and/or lookup method may utilize dᵢₙₜₑᵣᵥₐₗₛ=5 Hz and/or may divide the binary score in windows of L_{window}=6s and keep the dᵢₙₜₑᵣᵥₐₗₛL_{windows}=30 pairs with the highest strength s in each window. As a result, a final list of intervals may be outputted, which may be utilized during the database lookups or searches performed and/or executed by the system 10 and/or the lookup method.

For creating hashes, each triplet (iₐ, Δn, Δi) may be identified by a unique hash. Because the score may span on three octaves, iₐ∈[0, 35], 6 bits may be necessary to represent the score. In an embodiment, Δn∈[4, 30] frames≈[0.74, 5.6] s, may be encoded using 5 bits. Finally, Δi∈[−6, 6]\0 may be encoded on 4 bits. By stacking the three numbers, we get a single hash h of 15 bits. For each file or score, a set of hashes and their positions in the song may be obtained according to equation (21):

Hj={(n, [symbol] )} (21)

For matching hashes, an entire database may be created by associating each interval or hash with all its appearances in the studio files. Therefore, the present system 10 and/or the lookup method may fill each bin or hash h of the database 24, with pairs of values (j, nₐ), where j is the index of the studio file in the database, and nₐ is the position of the interval in the binary score of the studio file or recording j. As a result, the database 24 may allow us to find exact matches of an interval in all studio files or recordings. To be more robust to tempo changes and noise, the present system 10 and/or the lookup method may not only look for perfect interval matches, but also for the same interval with slight time variations: Δn±1 which may be achieved by looking for perfect matches of (iₐ, Δn+1, Δi) and (iₐ, Δn−1, Δi). Such search may be performed for each interval of the query file or recording. The raw output of the lookup may be, for each file j of the database, the set of time indices and hashes of matching pairs between the query or live file or recording and the studio file or recording according to equation (22):

[symbol]

ⱼ={(nₐ,n_{b}, [symbol] )|∃ [symbol] ∈ [symbol] ,(nₐ, [symbol] )∈ [symbol] _{query},(n_{b}, [symbol] )∈ [symbol] ⱼ} (22)

When finding the most likely studio files, the system 10 and/or the lookup method may apply the following processing independently to each file 26 or studio recording. In embodiments, each file from the database 24 may be rated according to a plurality of criteria that may be computed using the set of matches Mj.

In an embodiment, a first indicator of the criteria may be the density of matches between the query or live recording and the studio recording according to equation (23):

$${I}_{d} [ j ] = \frac{\vert {ℳ}_{j} \vert}{{N}_{query} + {N}_{j}} \qquad ( 23 )$$

where N_{query} is the length of the query (in frames), and Nⱼ is the length of the studio file.

In an embodiment, second and third indicators of the criteria may also be densities, but the number of matches |Mj| may be computed differently. The number of unique hashes that match between the two files may be computed according to equations (24) and (24):

$${I}_{u} [ j ] = \frac{\vert {f}_{u} ( {ℳ}_{j} ) \vert}{{N}_{query} + {N}_{j}} \qquad ( 24 )$$

fᵤ:(x,y,z) [symbol] z (25)

In an embodiment, the last density may count unique hashes in the query or live recording as many times as the unique hashes may appear, but the unique hashes may be counted only once by matches created in the studio recordings according to equations (26) and (27):

$${I}_{v} [ j ] = \frac{\vert {f}_{v} ( {ℳ}_{j} ) \vert}{{N}_{query} + {N}_{j}} \qquad ( 26 )$$

fᵥ:(x,y,z) [symbol] (x,z) (27)

In embodiments, Δδ may be in a range from 0.5 to 10 seconds and a final indicator of the criteria may take into account that the matches need to be aligned for the two files or recordings to represent the same song. The offset or delay between the two files for each matching hashes: δ=nₐ−n_{b} may be computed. For example, observed distribution of delays by creating a histogram of nₐ−n_{b}, using 5-second bins, may be obtained. Bins of Δδ=5s may appear to be too large; however, the resulting search is more robust to tempo changes between the live recordings and the studio recordings. The count Dj[δ] of matches in a specific bin δ may be compared to an expected density in a case where the matches would be uniformly distributed (nₐ, n_{b})˜(U[0, N_{query}−1], U[0, Nj−1]). A likelihood ratio may be estimated for each bin, by keeping the maximum value as the last indicator, in accordance with equations (28) and (29):

$$\begin{matrix} {I}_{l} [ j ] = {max}_{δ} ( \frac{{D}_{j} [ δ ]}{Δ δ} \frac{1}{{D}_{j , th} [ δ ]} ) & ( 28 ) \\ {D}_{j , th} [ δ ] = \{ \begin{matrix}max ( \frac{2}{3} , \frac{δ + {N}_{j}}{min ( {N}_{query} , {N}_{j} )} {I}_{d} [ j ] & if δ < - {N}_{j} + min ( {N}_{query} , {N}_{j} ) \\ max ( \frac{2}{3} , \frac{{N}_{query} - δ}{min ( {N}_{query} , {N}_{j} )} {I}_{d} [ j ] & if δ > {N}_{query} - min ( {N}_{query} , {N}_{j} ) \\ {I}_{d} [ j ] & otherwise\end{matrix} & ( 29 )\end{matrix}$$

To avoid giving too much importance to short matches at the beginning or end of files, the uniform density I_{d}[j] may not be divided by more than 3/2. The above-mentioned four indicators may determine the order in which the database songs (i.e., studio recordings) may be fine-tested against the query or live recordings. The files are reordered according to each indicator. As a result, four rankings R_{d}, Rᵤ, Rᵥ, Rₗ according to equation (30):

$$R . [ r ] = j , {\sum }_{i} ( I . [ i ] > I . [ j ] ) = r \qquad ( 30 )$$

Instead of combining the values of the indicators that may not have the same order of magnitude, the rankings may be combined by “interleaving” the results according to equation (31):

$${R}_{tot}^{′} [ r ] = \{ \begin{matrix}{R}_{l} [ \frac{r}{4} ] & if r ≡ 0 & ( mod 4 ) \\ {R}_{d} [ \frac{r - 1}{4} ] & if r ≡ 1 & ( mod 4 ) \\ {R}_{u} [ \frac{r - 2}{4} ] & if r ≡ 2 & ( mod 4 ) \\ {R}_{v} [ \frac{r - 3}{4} ] & if r ≡ 3 & ( mod 4 )\end{matrix} \qquad ( 31 )$$

and keeping the first occurrence of each index j in R′ₜₒₜ to obtain Rₜₒₜ according to equation (32):

Rₜₒₜ[r]=R′ₜₒₜ[min(q|R′ₜₒₜ[q]∉{Rₜₒₜ[t]}_{t∈[0,r-1]})] (32)

The efficiency of the lookup method may be estimated by looking at the rank r of ground truth matches in the database 24.

In some embodiments, the query may contain more than one song which may also be referred to large chunks or long queries. Although first results showed that the lookup algorithm was sometimes robust to the large chunks or long queries, splitting the large chunk into smaller queries may improve the rank of ground truth matches. The splitting process may be the same, or substantially the same, except that the four indicators are computed for each “window” or each smaller query. The maximum value of each indicator across all windows is kept and the ranking method may the same, or substantially the same, as the above-mentioned ranking method.

The present system 10 and/or the lookup algorithm may process, match and/or handling transposed songs by utilizing the binary score S, whereby transposing the song may be equivalent to shifting S along the notes dimension. In an embodiment, the system 10 and/or the lookup algorithm may define a simple transposition operator Tₜ, where t∈Z is the transposition in semitones according to equation (33):

$${T}_{t} ( S ) = \{ \begin{matrix}[ \begin{matrix}{0}_{t , {N}_{frames}} \\ {S}_{0 ; {N}_{noites} - 1 - t , 0 ; {N}_{frames} - 1}\end{matrix} ] & if t \geq 0 \\ [ \begin{matrix}{S}_{- t ; {N}_{noites} - 1 , 0 ; {N}_{frames} - 1} \\ {0}_{- t , {N}_{frames}}\end{matrix} ] & if t < 0\end{matrix} \qquad ( 33 )$$

In an embodiment, S_{a:b,d:e} is the sub-matrix of S obtained by keeping the rows a≦r≦b and the columns d≦c≦e. By using the new score Tₜ(S), the system 10 and/or the lookup algorithm may perform, conduct and/or make a new query and look for matches in the database 24. Although looking for transposed version of the songs may be a simple process, it may increase the probability of finding false positives as outputs.

To compare the indicators across transpositions and query windows, the values of the indicators may first be normalized in each window. In embodiments, the average value of an indicator may vary depending on the query or live recording. Therefore, a global normalization value may not be set. Instead, the values may be divided by a given percentile, such as, for example, one percent. The position, in descending order of the indicator's values I., of the normalization factor may be determined according to equation (34):

p_{0.01}=max(pₘᵢₙ,min(pₘₐₓ,1.01×N_{files}))−1 (34)

where N_{files} is the number of files in the database, pₘᵢₙ=2, and pₘₐₓ=100. The indicator's values I.[i] may first be sorted, then may be updated according to equation (35):

$$I . [ i ] ← \frac{I . [ i ]}{I . [ {p}_{0.01} ]} \qquad ( 35 )$$

When the query contains several windows, the results for each window may be normalized independently. Subsequently, the maximum value of each indicator across all the windows be kept.

In examples where several transpositions were tested, coherence between all the indicators may be checked by the system 10 and/or the lookup algorithm. If a database file is a true match, all indicators will have their maximum value for the right transposition. When the database file is not a match, there might be incoherence between indicators (i.e., indicators may take maximum value for different transpositions), but it is irrelevant.

If, for example, three or all four indicators agree on a transposition t, then it may be selected as the most probable and the indicators' values may be kept for the transposition t. Because the likelihood indicator Iₗ is the most accurate, the suggested transposition may be utilized by the system 10 and/or the lookup algorithm when only two indicators agree. Finally, the ranking is performed using equation (32).

Once the ranking of the candidates has been computed, real matches may, or should, be found among the candidates. The fine matching algorithm is used by the present system 10 and/or method. The database files (i.e., studio recordings) are tested in ranking order by the fine matching algorithm. The fine matching algorithm may stop testing the database files or studio recording if a database file or song (i.e., studio recording) matches each other by at least 70%, preferably 80% or more, most preferable 90% or more, of a live query or recording. Otherwise, the fine matching algorithm stops testing when a maximum rank has been reached.

In one testing example, the full database contained 9000 studio songs or recordings, the maximum rank was set to 100, and 120 live chunks uploaded to a website were used as queries, which represented 148 matches in the database whereby some queries matched with more than one database file. The matches were manually labelled and/or listed everything that could be detected by a human ear. This labeling and/or listing included: short excerpts; transposed songs compared to the studio version; extreme variations in tempo; and rearrangement, such as, for example, the instruments and/or the structure of the song change. The performance of the present system 10 and/or present computer instructions and/or algorithms looking for transposed songs has precision at about 95%, recall at about 74.4% and Fₘₑₐₛᵤᵣₑ(β=0.5) at about 90.1%. The results without looking for transposed songs had precision at about 92.2%, recall at about 72.9% and Fₘₑₐₛᵤᵣₑ(β=0.5) at about 87.5%. Thus, the inventive system 10, methods and/or computer instructions or algorithms for search, comparing and matching live recordings to studio recording achieve improved precision and/or recall with or without looking for transposed songs or recordings. Therefore, the present methods and/or computer instructions or algorithms improve the efficiency and effectiveness of the inventive system 10 when search, comparing and/or matching live and studio recordings.

It may be noted that the performances of the present system 10 and methods are not so different when looking for transposed songs. This may be due to the fact that using transpositions creates more “noise”: for each database file and the maximum value between five transpositions is kept. Therefore, matches that were already weak are pushed back in the ranking, and are not tested by the fine matching algorithm. However, new true matches are detected, that could not be detected before, which may improve the matching results.

In embodiments, the above-mention technique used to rank the files is scalable to large database; however, the true match may not always be located in first position. Several indicators may be used to attempt to robustify the ranking and the results depend on the accuracy of the features (i.e., binary scores) computed. Improving the accuracy of the computed feature improves the ranking results.

The use of binary features by the present system 10, method and/or computer instructions may discard valuable information from the original audio files. However, improvements are achieved by finding other features/classification methods that could help with the decision process, such as, for example, either to confirm a match, or as a first lookup in the database, to reduce the number of candidates. The discarded information may include, for example, timbre information and/or tempo, although in a sense, this is still contained in the binary score.

In alternative embodiments, the present system 10, method and/or computer instructions may utilize, conduct or run one or more other testing methods to detect and/or determine matches between the studio and live recordings. For example, the computer instructions may further comprise one or more additional algorithms, that when executed by the system 10, may utilize, conduct and or run one or more testing methods to match the live and studio recordings. The one or more other testing methods may include, but are not limited to, a local histograms method or algorithm (hereinafter “local histograms method”), a dynamic programming method and/or a Hidden Markov Model (hereinafter “HMM”) training on binary features method.

For the local histograms method, recurring chords in each song may be utilize to find a limited number of candidates. As a result, the song may then be described by the histogram/distribution of these chords. In embodiments, the local histograms method may be utilized as the database lookup method or in replacement of the database lookup method.

In an embodiment, a chord is defined by, for example, a set of 2 to 5 notes occurring in the same frame or a set of 3 notes occurring in the same frame. The local histograms method search for, detects and/or identifies two different types of chords, major and minor, which can be described by these two masks:

1 0 0 0 1 0 0 1 0 0 0 0
1 0 0 1 0 0 0 1 0 0 0 0

There are 12 possible roots for both types of chords, which makes 24 chords. The local histograms method searches or looks for, detects and/or identifies combinations of 3 notes, and several chords when be detected in the same frame.

When looking for chords, the local histograms method may merge the octaves in the binary score to obtain a single octave, similar to the chroma features according to equation (36):

$${S}^{′} = ( {1}_{1 , \frac{{N}_{notes}}{12}} ⊗ {I}_{12} ) S > 0 \qquad ( 36 )$$

The comparison may be applied element by element. As a result, a 12×N matrix may be obtained representing the occurrences of each note in time, no matter the octave. From the matrix, a 24×N matrix C may be created representing the occurrences of the 24 possible chords in the score.

Local histograms may be computed on Lₕᵢₛₜ consecutive frames of the matrix C every Lₕᵢₛₜ/2 frames, by summing and normalizing the number of occurrences of each chord, according to equation (37):

$$H [ k , l ] = \frac{{\sum }_{n = {lL}_{hist} / 2}^{{lL}_{hist} / 2 + {L}_{hist} - 1} C [ k , n ]}{{\sum }_{c = 0}^{23} {\sum }_{n = {lL}_{hist} 2}^{{lL}_{hist} / 2 + {L}_{hist} - 1} C [ c , n ]} \qquad ( 37 )$$

In an embodiment, Lₕᵢₛₜ may be the number of frames equivalent to 50 s.

To efficiently search or look for, detect and/or identify potential matching histograms, frequencies of the histograms may then be quantized in four “buckets”. The six most frequent chords may be labelled “1”, and other chords may be labelled similarly until the six less frequent chords, which may be labelled “4” to produce and/or create a rough approximation. The rough approximation may be more convenient to compare two distributions, than, for example, using the Kullback-Leibler (hereinafter “KL”) divergence or other similar measures. The distance between two histograms is defined using the buckets. For each chord, quantized frequencies may be compared and a distance may be assigned:

| | 1 | 2 | 3 | 4 |
|---|---|---|---|---|
| 1 | 0 | 1 | 2 | 3 |
| 2 | 1 | 0 | 0 | 2 |
| 3 | 2 | 0 | 0 | 0.5 |
| 4 | 3 | 2 | 0.5 | 0 |

These values were chosen to reflect the importance of finding (dis)similar chord “frequencies”. For example, a chord that frequently occurs in a score (labelled “1”), and that is non-existent in another file (labelled “4”) is a sign of two dissimilar scores. On the contrary, differences between labels “2” and “3” may be due to the quantization, and should not weigh too much (or not at all) in the distance. The distance is obtained by summing weights of all chords comparisons.

Using several local histograms for each song, every histogram may be stored in the database 24 by associating the quantized frequency of each chords with the appropriate “bucket”. The distances between the query or live recording and studio recordings in the database 24 may be computed gradually by starting by the most frequent chords. In songs where these same chords do not appear, the distance may rapidly increase, and the non-matching songs may be discarded in the search process.

For two local histograms to match, the distance between the two local histograms must, or should be, for example lower or equal to about 8.5. For the query or live recording to match a studio recording from the database 24, at least three local histograms must match between the two files or recordings. However, a single local histogram from the query or live recording matching three different histograms in a studio recording may be considered a match.

In an example, a database composed of about 9000 songs was used as a “large scale” database such as, database 24. The diversity of songs or studio recordings in length and genres may be representative of a real database usable at the commercial level, and the results obtainable more likely scale with the number of files or studio recordings in the database 24. The same 143 ground truth matches as in the “fine matching” testing were utilized in this example—but this time within the larger, 9000 song database.

On average, the search described here returned 7% of the database as candidates for “fine matching” testing. Half of the time, 4.7% of the database was returned (the median of the number of candidates per query). The real match was present in the list of candidates for 117 queries, representing 82% of all possible matches, and 91% of easy matches.

In embodiments, a dynamic programming method may be utilized by the present system 10, methods and/or computer instructions to compare sequences of data, such as, for example, strings of characters. The dynamic programming method may perform the same as, or substantially the same as, the fine matching algorithm. A similarity measure between features (i.e., the dot product) may be defined and the DTW algorithm may be applied to find the path that best synchronizes, or substantially better synchronizes, the two files 26. Several sets of parameters were tested in test examples, but improved results over the local histograms method were not achievable.

In embodiments, the HMM training on binary features method or algorithm (hereinafter “HMM method) may be performed, executed and/or implemented by the system 10, methods and/or computer instructions to match live recordings to studio recordings of the same song. The HMM on binary features is a method that may extract more information from the digital audio tracks by relying on the binary scores of the digital audio tracks. However, the HMM on binary features method is not directly a matching algorithm and may be applied on a single track to find the most recurrent combinations of notes or chords within the binary scores of the digital audio tracks, as well as, their temporal relationship, such as, for example, which notes or chords may usually come before and/or after which notes and/or chords.

The binary score S is the list of activated notes over time. The system 10, HMM method and/or computer instructions may find, determine and/or identify a high-level description of the binary score S by looking for the different sections of a song (i.e., chorus, verse . . . ), the specific chords which possibly have more than 3 notes, the melody, . . . etc. In an embodiment, the frames may first be clustered according to activated notes of the frame. The K-means algorithm may be applied to binary data by using the Hamming distance, for example. However, an assumption may be made that each observation in the score is composed of the notes of a chord, possibly recurring throughout the score and therefore the most frequent, and a melody. The melody may be composed of less frequent notes, possibly even outside the tonality of the song. Thus, there may be a probabilistic aspect to the binary observation made of the studio recording.

Each frame of the binary score may be modeled as a mixture of Bernoulli variables. Each “chord” (component) c may be defined by a set of Nₙₒₜₑₛ probabilities corresponding to the probability of each note n being activated, given that such chord is observed according to equation (38):

p(S[n,o]=1|c)=φₙ^{c} (38)

The probability of observing a complete frame, assuming independency between the notes, may be in accordance with equation (39):

$$\begin{matrix}p ( S [ \cdot , o ] ) = {\sum }_{c} [ S [ \cdot , o ] \vert c ) p ( c ) \\ = {\sum }_{c} p ( c ) {\prod }_{n} p ( S [ n , o ] \vert c ) \\ = {\sum }_{c} p ( c ) {\prod }_{n} ( S [ n , o ] {ϕ}_{n}^{c} + ( 1 - S [ n , o ] ) ( 1 - {ϕ}_{n}^{c} ) ) \\ = {\sum }_{c} p ( c ) {\prod }_{n} {( {ϕ}_{n}^{c} )}^{S [ n , o ]} {( 1 - {ϕ}_{n}^{c} )}^{( 1 - S [ n , o ] )}\end{matrix} \qquad ( 39 )$$

An estimate of each chord c defined by {l^{c}.} and their probabilities p(c)=π_{c} may be found, determined and/or identified, using an expectation maximization algorithm. First, the responsibility of each chord c, for each observation o is computed in accordance with equation (40):

$$\begin{matrix}γ [ c , o ] = p ( c \vert S [ \cdot , o ] ) \\ = \frac{p ( c ) p ( S [ \cdot , o ] \vert c )}{{\sum }_{d} p ( d ) p ( S [ \cdot , o ] \vert d )} \\ = \frac{{π}_{c} {\prod }_{n} {( {ϕ}_{n}^{c} )}^{S [ n , o ]} {( 1 - {ϕ}_{n}^{c} )}^{( 1 - S [ n , o ] )}}{{\sum }_{d} {π}_{d} {\prod }_{n} {( {ϕ}_{n}^{d} )}^{S [ n , o ]} {( 1 - {ϕ}_{n}^{d} )}^{( 1 - S [ n , o ] )}}\end{matrix} \qquad ( 40 )$$

Then, the parameters {π_{c}} and {l^{c}ₙ} may be re-estimated using the responsibilities γ according to equations (41) and (42):

$$\begin{matrix}{π}_{c} = \frac{{\sum }_{o} γ [ c , o ]}{N} & ( 41 ) \\ {ϕ}_{n}^{c} = \frac{1}{{\sum }_{o} γ [ c , o ]} {\sum }_{o} γ [ c , o ] S [ n , o ] & ( 42 )\end{matrix}$$

where N is the number of frames (observations).

Because the notes appearances may highly depend on the tonality of the song, the patterns/chords {l^{c}ₙ} may not be randomly initialized. Instead, the overall distribution of the notes is used according to equations (43):

$${( {ϕ}_{n}^{c} )}^{init} = max ( 0.05 , min ( 0.95 , \frac{{\sum }_{o} S [ n , o ]}{N} + 2 σ ( u [ n , c ] - 0.5 ) ) ) \qquad ( 43 )$$

where u is uniformly-distributed noise. The initial chord probabilities may be uniformly distributed.

Such procedure may be iterated until the convergence criterion may be satisfied. The HMM method looks at, determines and/or identifies the evolution of the (log)likelihood of the observation p(S), and wait or continues iterations until the improvement between two iterations may no longer be significant. The performance of the HMM method or algorithm may, in part, depend on the number of chords (components) chosen. One technique for determining the appropriate number of chords may involve computing a criterion of some kind, such as, for example, the Akaike Information Criterion.

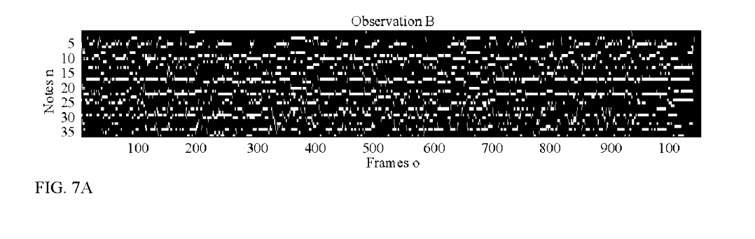

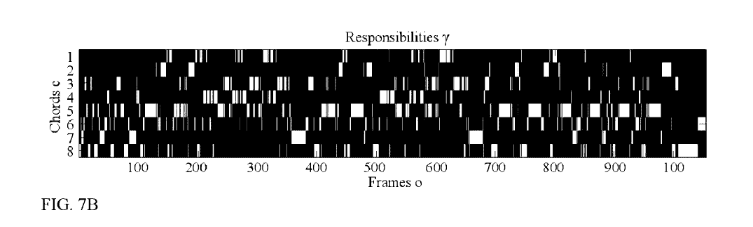

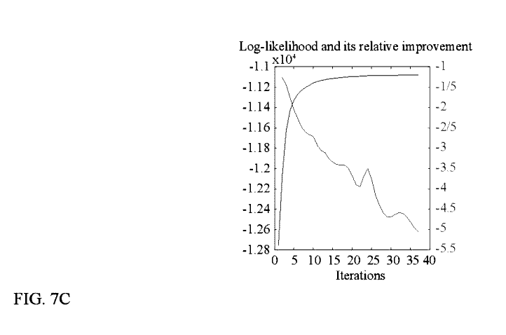

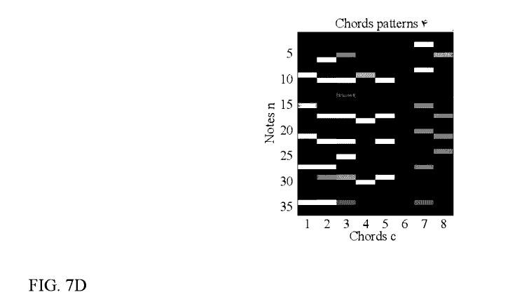

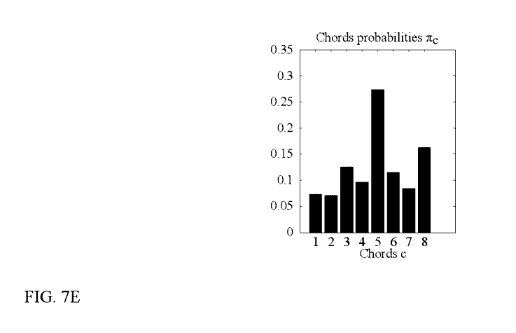

FIGS. 7A-7E illustrate an example of execution of the BMM method or algorithm on a song named “Some Unholy War” by an artist named Amy Winehouse. FIGS. 7A-7E show the responsibility for a chord usually lasts several frames and the global structure of the song.

As set forth above, the BMM method or algorithm may define a parametric description of the song by finding the most likely recurring chords throughout the score or recording. The BMM method or algorithm may go even further by finding the temporal connections between the chords of the score or recording. Indeed, only a few different chords progressions may usually be played in a song. This time dependency may be added by defining a HMM method where the observations are Bernoulli variables, wherein {l^{c}ₙ} may be the emission probabilities, {π_{c}} may be the initial state (chord) probabilities, and A may be the transition matrix, where:

A[c,d]=p(z_{o+1,d}|z_{o,c}) (44)

z_{o,c} is the variable that is equal to 1 if the HMM is in state c at frame o, 0 otherwise. A [c, d] is therefore the probability of jumping to state/chord d when currently in state c.

Using a method or algorithm similar to the EM algorithm (see Christopher M. Bishop, “Pattern Recognition and Machine Learning”), the method may be trained on a single sequence of observations (i.e., the score S). A first step of the method or algorithm may be to compute forward and backward “responsibilities”, which may directly present the scaled versions and avoid going to zero after a few observations according to equations (45) and (46):

$$\begin{matrix}\begin{matrix}\hat{α} ( {z}_{o , c} ) = p ( {z}_{o , c} \vert S [ \cdot , 1 ] … S [ \cdot , o ] ) \\ = \frac{1}{{f}_{o}} p ( S [ \cdot , o ] \vert {z}_{o , c} ) {\sum }_{d} \hat{α} ( {z}_{o - 1 , d} ) p ( {z}_{o , c} \vert {z}_{o - 1 , d} ) \\ = \frac{1}{{f}_{o}} ( {\prod }_{n} {( {ϕ}_{n}^{c} )}^{S [ n , o ]} {( 1 - {ϕ}_{n}^{c} )}^{( 1 - S [ n , o ] )} ) {\sum }_{d} \hat{α} ( {z}_{o - 1 , d} ) A [ d , c ]\end{matrix} & ( 45 ) \\ \begin{matrix}\hat{α} ( {z}_{0 , c} ) = \frac{1}{{f}_{0}} {π}_{c} p ( S [ \cdot , 0 ] \vert {z}_{0 , c} ) \\ = \frac{1}{{f}_{0}} {π}_{c} ( {\prod }_{n} {( {ϕ}_{n}^{c} )}^{S [ n , 0 ]} {( 1 - {ϕ}_{n}^{c} )}^{( 1 - S [ n , 0 ] )} )\end{matrix} & ( 46 )\end{matrix}$$

where fₒ ensures that the α̂ sum to 1 at each observation o. The backward recursion is defined in a similar fashion according to equations (47) and (48):

$$\begin{matrix}\begin{matrix}\hat{β} ( {z}_{o , c} ) = \frac{1}{{f}_{o + 1}} {\sum }_{d} \hat{β} ( {z}_{o + 1 , d} ) p ( S [ \cdot , o + 1 ] \vert {z}_{o + 1 , d} ) p ( {z}_{o + 1 , d} \vert {z}_{o , c} ) \\ = \frac{1}{{f}_{o + 1}} {\sum }_{d} \hat{β} ( {z}_{o + 1 , d} ) ( {\prod }_{n} {( {ϕ}_{n}^{d} )}^{S [ n , o + 1 ]} {( 1 - {ϕ}_{n}^{d} )}^{( 1 - S [ n , o + 1 ] )} ) A [ c , d ]\end{matrix} & ( 47 ) \\ \hat{β} ( {z}_{N - 1 , c} ) = 1 & ( 48 )\end{matrix}$$

Using the {fₒ}, the log-likelihood of the observation given the current model parameters may be obtained according to equation (49):

$$log ( p ( S ) ) = {\sum }_{o} log ( {f}_{o} ) \qquad ( 49 )$$

The responsibilities are in accordance with equation (50):

γ(z_{o,c})=\hat{α}(z_{o,c})\hat{β}(z_{o,c}) (50)

which may allow re-estimation of the initial states probabilities and the emission probabilities according to equations (51) and (52):

$$\begin{matrix}{π}_{c} = \frac{γ ( {z}_{0 , c} )}{{Σ}_{d} γ ( {z}_{0 , d} )} & ( 51 ) \\ {ϕ}_{n}^{c} = \frac{{Σ}_{o} γ ( {z}_{o , c} ) S [ n , o ]}{{Σ}_{o} γ ( {z}_{o , c} )} & ( 52 )\end{matrix}$$

Additionally, the conditional probabilities ξ(z_{o-1,c},z_{o,d})=p(z_{o-1,c},z_{o,d}|S) may be estimated according to equation (53):

$$( 53 )$$

$$\begin{matrix}ξ ( {z}_{o - 1 , c} , {z}_{o , d} ) = {f}_{o} \hat{α} ( {z}_{o - 1 , c} ) p ( S [ \cdot , o ] \vert {z}_{o , d} ) p ( {z}_{o , d} \vert {z}_{o - 1 , c} ) \hat{β} ( {z}_{o , d} ) \\ = {f}_{o} \hat{α} ( {z}_{o - 1 , c} ) ( {\prod }_{n} {( {ϕ}_{n}^{d} )}^{S [ n , o ]} {( 1 - {ϕ}_{n}^{d} )}^{( 1 - S [ n , o ] )} ) A [ c , d ] \hat{β} ( {z}_{o , d} )\end{matrix}$$

from which the transition matrix may be re-estimated according to equation (54):

$$A [ c , d ] = \frac{{Σ}_{o} ξ ( {z}_{o - 1 , c} , {z}_{o , d} )}{{Σ}_{e} {Σ}_{o} ξ ( {z}_{o - 1 , c} , {z}_{o , e} )} \qquad ( 54 )$$

In embodiments, the algorithm may be initialized with uniform initial state probabilities π_{c}. The emission/patterns may be initialized using the output of the BMM method or algorithm previous disclosed herein, to which noise may be added to avoid being too close to a local minimum. Finally, the state transition matrix A may be initialized with an identity matrix to which noise may also be added. However, one condition may be for the rows of matrix A to sum to 1.

As for the BMM method or algorithm, the iterative process may be stopped when the change between two iterations may be become negligible, in terms of log-likelihood. At each step or iteration, the emission probabilities {l^{c}ₙ} may be prevented from going to 1 or 0, to avoid obtaining too many null responsibilities for the associated state or chord. In an embodiment, the BMM method or algorithm may compute the product of note probabilities, having l^{c}ₙ=0 (respectively l^{c}ₙ=1) implies that p(S[•, o]|c)=0 if S[n, o]=1 (respectively S[n, o]=0), even if all other notes maximize the likelihood. Therefore, the BMM method or algorithm may threshold the probabilities after estimating the new parameters:

φₙ^{c}←min(0.995,max(0.005,φₙ^{c}))

It may be noted that training the HMM model on a single sequence may make the initial state probabilities {π_{c}} useless or substantially useless. Moreover, because the live recordings do not always start at the beginning of the song, the BMM method or algorithm may not utilize them to identify a query.

In embodiments, the present system 10, method and/or computer instructions may utilize the HMM model to find, determine and/or identify candidate matches. Once the parameters of the HMM model are found and/or determined, the parameter may be with other songs, and, therefore, other models. Several methods exist to compare HMM models, but most of the methods may be computationally expensive. To efficiently compare HMM models, the present system 10, methods and/or computer instructions may utilize, execute and/or implement a comparing method similar to that utilized by Sayed Mohammad Ebrahim Sahraeian, et al., “A Novel Low-Complexity HMM Similarity Measure,” 2010. The comparing method may compare the states by computing a distance (or divergence) between their emission distributions. To also compare the transitions, the “relevant” transitions of each model may be listed. The transition matrix A may be close to an identity matrix, with very low interstate probabilities and the set of relevant transitions may be defined by the emission probabilities of the two states according to equation (55):

[symbol]

={(φ.^{c},φ.^{d})|A[c,d]≧10⁻¹⁰} (55)

To compare two models, a similarity between each transition may be computed. Two transitions (l^{c}., l^{d}.)₁ and (l^{c}., l^{d}.)₂ of two different models may match if the dot products of the emission probabilities match according to:

$$( \frac{{{Σ}_{n} ( {ϕ}_{n}^{c} )}_{1} {( {ϕ}_{n}^{c} )}_{2}}{\sqrt{{{Σ}_{i} ( {ϕ}_{n}^{c} )}_{1}^{2} {{Σ}_{i} ( {ϕ}_{n}^{c} )}_{2}^{2}}} > {θ}_{state - match} ) ( \frac{{{Σ}_{n} ( {ϕ}_{n}^{d} )}_{1} {( {ϕ}_{n}^{d} )}_{2}}{\sqrt{{{Σ}_{i} ( {ϕ}_{n}^{d} )}_{1}^{2} {{Σ}_{i} ( {ϕ}_{n}^{d} )}_{2}^{2}}} > {θ}_{state - match} )$$

Finally, the number of matching transitions between the two models may be counted by the BMM method or algorithm. Although this may reduce the number of candidates, the results of the BMM method or algorithm may or may not be as good or accurate as results from the local histograms method.

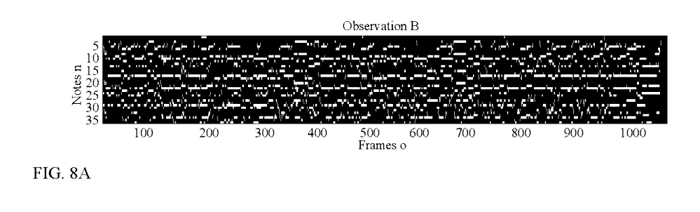

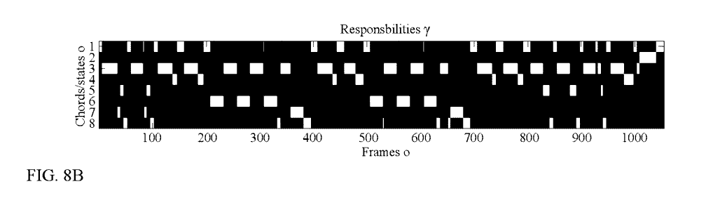

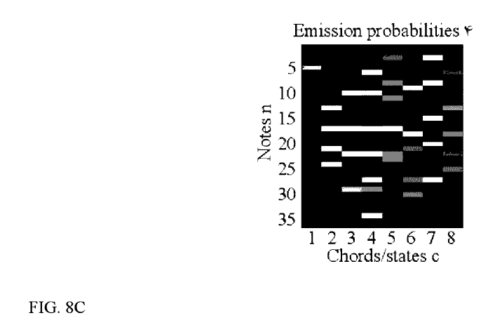

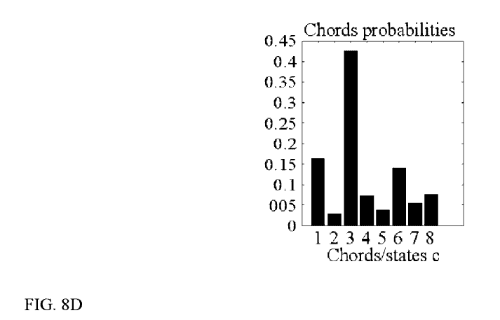

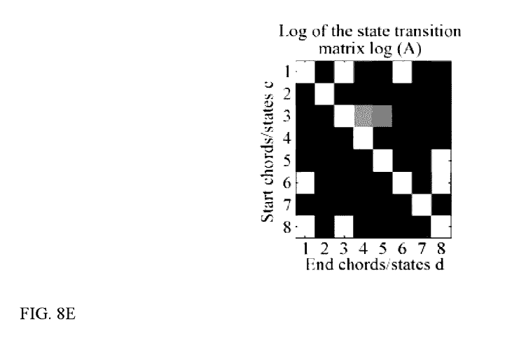

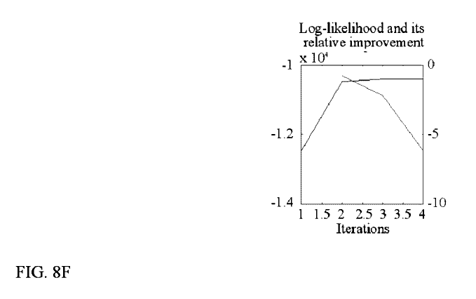

FIGS. 8A-8F illustrate an example of HMM training on the same song. The chords probabilities are not the initial states {π_{c}}, instead, the chords probabilities are defined by (Σₒy(z_{o,c}))/(Σ_{d}Σₒy(z_{o,d}). Different parts of the song are visible, such as, for example, the intro, ABABA, A (ad-lib) and the outro. It should be noted, in this example, that converging in only 4 iterations may be fast with the average number of iterations at about 50.

In embodiments, the present system 10, methods, computer instructions and/or computer algorithms may (i) create the database 24, or provide input 30, containing one or more studio recordings and/or one or more live recordings and/or (ii) may query, text and/or compare the one or more studio recordings and/or the one or more live recordings to determine, identify and/or calculate one or more matches within the database 24 and/or the input 30, whereby a match may be the same performance of the same song by the same artist or different performances of the same song by the same artist. In an embodiment, the present system 10, methods, computer instructions and/or computer algorithms may, independently for each recording in the database 24 and/or input 30, compute the binary score of each recording according to above-mentioned Equations (7) or (8) and/or may create a has database of hashes obtained from the binary score of each recording of the database 24 and/or input 30 according to the above-mentioned expressions leading to Equation. In order to find matches in the database 24 and/or input 30, the present system 10, methods, computer instructions and/or computer algorithms may, independently for each recording of the database 24 and/or input 30, compute the binary score of each recording according to above-mentioned Equations (7) or (8). Subsequently, for each query, the present system 10, methods, computer instructions and/or computer algorithms may utilize the lookup algorithm and/or the matching algorithm to determined and/or identify one or more matches between the recordings of the database 24 and/or input 30.

In an embodiment, the lookup algorithm may rank all the studio recordings of the database 24 and/or input 30 according to their “probability” of matching with the query file (i.e., live recording) according to the above-mentioned expressions leading to Equation (32). The lookup algorithm may consider and/or account for transpositions according to above-mentioned Equations (33), (34), and (35). Transposition information obtained, determined and/or calculated by the lookup algorithm may be stored in the database 24 and/or used in a subsequent step and/or by matching algorithm or step. The matching algorithm may utilize the query file (i.e., live recording) as the first file, and one database file (i.e., one studio recording) from the database 24 or input 30 as the second file. The matching algorithm may determine whether each database file is a match with respect to the query file according to above-mentioned Equation (19). The matching algorithm may repeat said process until at least one match is found, determined and/or identified or until a maximum number of tests or comparisons utilizing a plurality of the database files (i.e., studio recordings) is reached and/or are completed by the matching algorithm. The database files may be tested or compared in decreasing rank order or decreasing match likelihood. For each database file (i.e., studio recording), the most probable transposition is kept from the previous step. When testing or comparing the query file (i.e., live recording) against the database file (i.e., the studio recording), the binary score of the database filed may be shifted according to the most probable transposition found, determined and/or identified during the previous step.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

1. A computer-implemented method for matching digital audio files, the method comprising:
providing a group of digital audio tracks to a computer system, wherein the group is provided to the computer system as input files or stored in a database associated with the computer system, wherein the group comprises a first digital audio track and a second digital audio track, wherein the first digital audio track is a live recording of a song and the second digital audio track is a previously recorded studio recording of a song;
comparing audio features of the first and second digital audio tracks to determine whether the first and second digital audio tracks are a match comprising same performances of a same song or different performances of the same song; and
outputting bounds for the match when the first and second digital audio tracks are determined to match, wherein the bounds for the match comprise start and end times for the match in both the first and second digital audio tracks.

2. The method according to claim 1, wherein the first and second digital audio tracks contain variations in tempo of the same song.

3. The method according to claim 1, further comprising:
shifting one of the binary scores of the first and second digital audio tracks when a transposition of the same song is present within one of the first and second digital audio tracks.

4. The method according to claim 1, further comprising:
computing the binary score of each of the first and second digital audio tracks according to one of the following equations:
$$\begin{matrix}S [ i , n ] = ( {y}_{dB} [ i , n ] > {θ}_{active - note} ) , or & ( 7 ) \\ \overline{S} [ i , n ] = ( ( \frac{1}{J} {\sum }_{j} {S}_{j} [ i , n ] ) \geq {θ}_{group - active - note} ) . & ( 8 )\end{matrix}$$

5. The method according to claim 1, wherein the audio features are based on binary scores of the first and second digital audio files.

6. The method according to claim 5, the audio features comprise hashes obtained from the binary score of each of the first and second digital audio files.

7. The method according to claim 1, further comprising:
storing at least one selected from the outputted bounds and information associated with the match in a database of the computer system.

8. The method according to claim 7, further comprising:
producing a final output digital file based on one selected from the outputted bounds and the information associated with the match.

9. A computer-implemented method for matching digital audio files, the method comprising:
providing digital audio tracks to a computer system, wherein the digital audio tracks are provided to the computer system as input files or are accessible from a database associated with the computer system, wherein the digital audio tracks comprise at least one live recording of a song and one or more previously recorded studio recordings of a song;
computing, independently, a binary score of each of the one or more previously recorded studio recordings;
creating a hash database of hashes obtained from the binary scores of the one or more previously recorded studio recordings;
querying the at least one live recording and the one or more previously recorded studio recordings to determine one or more matches based on the created hash database by:
computing a binary score of the at least one live recording;
ranking the one or more previously recorded studio recordings according to probabilities of matching the at least one live recording based on the created hash database; and
testing each of the one or more previously recorded studio recording until a match with the at least one live recording is determined or until a maximum number of tests with the previously recorded studio recordings is reached, wherein the one or more previously recorded studio recordings are tested in decreasing rank order or decreasing match likelihood and the match is a same performance of the same song or a different performance of the same song; and
outputting, when the match has been determined, bounds for the match, wherein the bounds for the match comprise start and end times for the match in both the live and previously recorded studio recordings.

10. The method according to claim 9, wherein the computed binary score of the one or more previously recorded studio recordings is computed according to one of the following equations:
$$\begin{matrix}S [ i , n ] = ( {y}_{dB} [ i , n ] > {θ}_{active - note} ) , or & ( 7 ) \\ \overline{S} [ i , n ] = ( ( \frac{1}{J} {\sum }_{j} {S}_{j} [ i , n ] ) \geq {θ}_{group - active - note} ) . & ( 8 )\end{matrix}$$

11. The method according to claim 9, wherein the computed binary score of the at least one live recording is computed according to one of the following equations:
$$\begin{matrix}S [ i , n ] = ( {y}_{dB} [ i , n ] > {θ}_{active - note} ) , or & ( 7 ) \\ \overline{S} [ i , n ] = ( ( \frac{1}{J} {\sum }_{j} {S}_{j} [ i , n ] ) \geq {θ}_{group - active - note} ) . & ( 8 )\end{matrix}$$

12. The method according to claim 9, wherein the match is determined according to the following equation:
min(r_{1,2},r_{2,1})>−0.066max(L_{c})+3.1302 (19),
wherein L_{c} is in seconds and the r_{1,2}, r_{2, 1} are ratios between 0 and 1.

13. The method according to claim 9, further comprising:
storing, when the match has been determined, at least one selected from the outputted bounds and information associated with the match in a database of the computer system.

14. The method according to claim 13, further comprising:
producing a final output digital file based on one selected from the outputted bounds and the information associated with the match.
